(19) United States
(12) Patent Application Publication
(10) Pub. No.: US 2018/0163459 A1
(43) Pub. Date: Jun. 14, 2018

(54) DOOR SWEEP

(71) Applicant: RCR INTERNATIONAL INC., Boucherville (CA)

(72) Inventors: David MATHIEU, Glastonbury, CT (US); Jim SENER, Glastonbury, CT (US); Andrew REED, Glastonbury, CT (US)

(21) Appl. No.: 15/822,016

(22) Filed: Nov. 24, 2017

Related U.S. Application Data
(60) Provisional application No. 62/426,292, filed on Nov. 24, 2016.
(60) Provisional application No. 62/426,277, filed on Nov. 24, 2016.
(60) Provisional application No. 62/426,278, filed on Nov. 24, 2016.

(51) Int. Cl. E06B 7/23; E06B 7/26; F25D 23/08

(52) U.S. Cl. CPC E06B 7/2312; E06B 2001/707; F25D 23/082; E06B 7/26

(57) ABSTRACT

A door sweep comprises an elongated U-shaped body formed by a base and a pair of upright walls, the U-shaped body configured for being mounted to a bottom portion of a door. The elongated U-shaped body may float relative to the bottom portion of the door when installed. Biasing member(s) in the elongated U-shaped body may bias the downwardly base away from the bottom portion of the door. A fastener cover may be connected to one of the upright walls, with a hinge formed at a junction between the fastener cover and U-shaped body, for hinging the fastener cover. Hinges may be formed at a junction between the base and each of the upright walls, for hinging the upright walls.

### CROSS-REFERENCE TO RELATED APPLICATION

The present application claims the priorities of U.S. Provisional Patent Application No. 62/426,292, of U.S. Provisional Patent Application No. 62/426,277, and of U.S. Provisional Patent Application No. 62/426,278, all filed on Nov. 24, 2016 and all incorporated herein by reference.

### TECHNICAL FIELD

The present application relates to door sweeps of the type mounted to bottom edges of doors as weatherstripping. Such door sweeps may also be known as weatherstripping or weatherstrips, door bottoms, etc.

### BACKGROUND OF THE ART

Door sweeps are commonly used to seal the gap between the bottom edge of a door and the floor, door sill, etc. Weather the door is an interior door or an exterior door, it is desired to prevent air infiltration through the gap. There however resides need for improvement in such door sweeps, whether in terms of packaging efficiency, ease of installation, sealing efficiency, and/or esthetics.

### SUMMARY

According to the first embodiment, there is provided a door sweep comprising: an elongated U-shaped body formed by a base and a pair of upright walls, the U-shaped body configured for being mounted to a bottom portion of a door, the elongated U-shaped body configured for floating relative to the bottom portion of the door when installed, and at least one biasing member in the elongated U-shaped body and configured for biasing the downwardly base away from the bottom portion of the door.

According to a second embodiment, there is provided a door sweep comprising: an elongated U-shaped body formed by a base and a pair of upright walls, the U-shaped body configured for being mounted to a bottom portion of a door, and a fastener cover connected to at least one of the upright walls, a hinge formed at a junction between the fastener cover and U-shaped body, for hinging the fastener cover between an opened condition in which the upright wall is exposed to receive fasteners, and a closed position in which the fastener cover is held captive to a remainder of the door sweep.

According to a third embodiment, there is provided a door sweep comprising: an elongated U-shaped body formed by a base and a pair of upright walls, the U-shaped body configured for being mounted to a bottom portion of a door, and hinges formed at a junction between the base and each of the upright walls, for hinging the upright walls between a stowed condition in which the upright walls are stowed toward the base, and a deployed condition in which the upright walls are upright for installation to the bottom portion of the door.

### DESCRIPTION OF THE DRAWINGS

FIG. 1 is a schematic perspective view of a door with a door sweep, such as the ones of the present disclosure, mounted to a bottom edge thereof;

FIG. 2 is a perspective view of a biased door sweep of an embodiment of the present disclosure.

FIG. 3 is an end view of a door sweep of another embodiment of the present disclosure, with a fastener cover opened;

FIG. 4 is an end view of the door sweep of FIG. 3 with the fastener cover closed;

FIG. 5 is an end view of the door sweep of FIG. 3 with a different arrangement of the fastener cover;

FIG. 6 is a perspective fragmented view of a foldable door sweep of yet another embodiment of the present disclosure, with hinged walls in a deployed condition, with bubble insert;

FIG. 7 is an end view of the foldable door sweep of FIG. 6, with hinged walls in a stowed condition; and

FIG. 8 is an end view of the foldable door sweep of FIG. 6, with hinged walls in a deployed condition.

### DETAILED DESCRIPTION

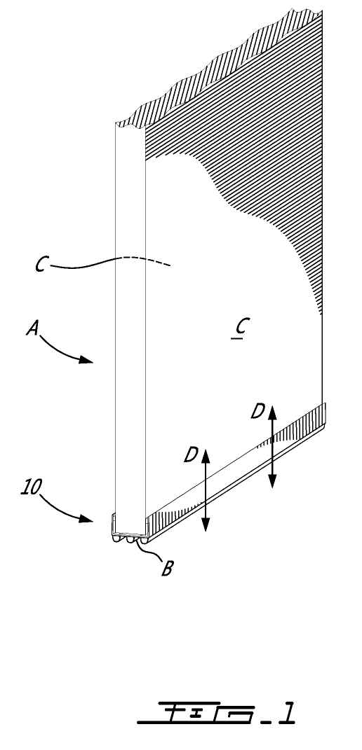

Referring to the drawings and more particularly to FIG. 1, there is illustrated a door A. The door A is a conventional door, with a bottom edge surface B and main surfaces C. The door A is displaceable, e.g., hinged to a structure, between a closed position and an open position. A gap is present between the bottom edge surface B of the door A and the ground, namely the floor, sill, ledge, etc. The door A may have any appropriate width, including 1¾″ and 1⅜″. A door sweep 10 in accordance with the present disclosure is mounted to the door A so as to extend below the bottom edge surface B, to seal the gap. The door sweep 10 may also be known as weatherstripping or weatherstrips, door bottoms, etc, as possible names. However, for simplicity, the expression “door sweep” will be used throughout, and is intended to include other known names for such devices. The door sweep 10 extends most, if not all, of the length of the bottom edge surface B. Moreover, although the door sweep 10 is shown as being mounted to the bottom edge surface B, it may also be mounted to the top edge surface of the door A. The door sweep 10 may be made of any appropriate polymeric materials, metallic materials, natural fibers, or a combination or composites thereof, with additional details provided below.

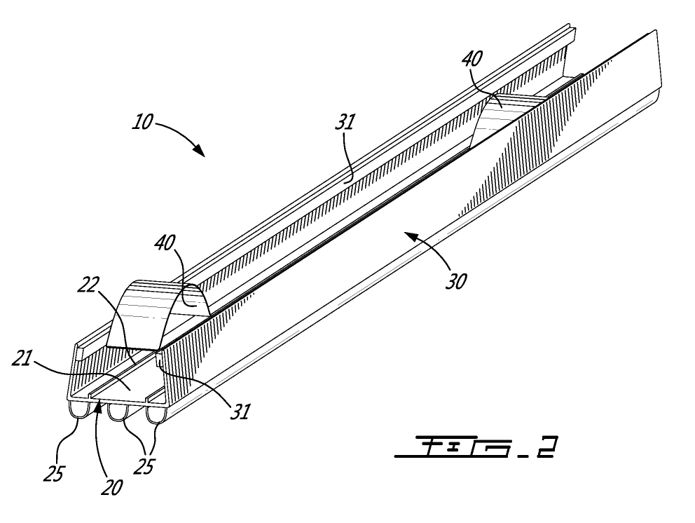

Referring to FIG. 2, an embodiment of the biased door sweep 10, the biased door sweep, is shown in greater detail. The biased door sweep 10 has a U-shaped body, with a base 20 and upright walls 30, to form an elongated receptacle for installing the biased door sweep 10 to a lower portion of the door A. The base 20 faces the bottom edge surface B, while the upright walls 30 face opposite ones of the main surfaces C. The base 20 may support additional sealing components to seal the gap between the door A and the ground. The upright walls 30 are used to hold the biased door sweep 10 to the lower portion of the door A, as described hereinafter. However, as explained hereinafter, the biased door sweep 10 is floatingly connected to a bottom portion of the door, and not fixedly secured to it. The biased door sweep 10 may move in direction D as shown in FIG. 1. In an embodiment, the biased door sweep 10 is fastener-less, without fasteners. In another embodiment, the biased door sweep 10 is connected to the door A by fasteners mounted in slots in the biased door sweep 10—concurrently forming translation joints—allowing the movement in direction D.

The base 20 has an elongated body 21. The elongated body 21 may define one or more elongated track 22. Although not visible, throughbore(s) may be defined in the elongated body 21 for the drainage of liquids. Bubbles 25 (i.e., one or more bubbles) project downwardly from the elongated body 21. The bubbles 25 may be known as elongated hollow seals, hollow gaskets, seal strips, hollow seal strip, etc. It is considered to co-extrude the bubbles 25 with the elongated body 21. The co-extrusion would enable the use of two different materials, or the same material with different properties. The elongated body 21 provides structural integrity to the biased door sweep 10, while the bubbles 25 seal the gap and provide some insulation. The elongated body 21 may therefore have plastomeric properties so as to have limited elastic deformation, while the bubbles 25 have elastomeric properties to deform while rubbing against the ground. According to another embodiment, the bubbles 25 are part of an insert that is separate from the body 21. Such a bubble insert may be slid or deformed into engagement with hooks of the elongated body 21.

Instead of or in complement to the bubble(s) 25, various other elongated features to perform sealing. One or more elongated bubbles 25 are hollow members that encapsulate air and hence act as insulators. Alternatively, the bubbles 25 may be made of a low-density or medium-density foam to provide insulation. Deflectors (a.k.a., wipers) may also project downwardly to contact the ground. The deflectors form a vapor or liquid barrier, between the body 21 and the floor. Drainage channels may be aligned with the throughbores in the elongated body 21 to concurrently contribute to the drainage of liquids.

Referring to FIG. 2, the upright walls 30 project upwardly from the base 20. According to an embodiment, the upright walls 30 are elongated and extend concurrently with the base 20. The upright walls 30 and 30′ may be extruded with the base 20, to as to form an integral component. The extrusion of the upright walls 30 with the base 20 may be an extrusion or a co-extrusion. Contact strips 31 may contact the main surfaces C of the door, and therefore form joint therewith for the biased door sweep 10 to smoothly slide up and down on the bottom portion of the door A. The contact strips 31 may therefore be made of a low-friction polymer. Other components may be present on the upright walls 30, such as a deflector in the event that the biased door sweep 10 is used on an exterior door. As the biased door sweep 10 grasps the bottom portion of the door A, the spacing between the free top ends of the upright walls 30 is such that the upright walls 30 apply a pressure to the bottom portion of the door A. This pre-installation distance is less than the thickness of the bottom of the door A, whereby the installation of the biased door sweep 10 to the bottom of the door A a hinging deformation of the upright walls 30. In an embodiment, the hinging deformation is an elastic deformation. The space between the free top ends of the upright walls 30 is further reduced by the presence of the contact strips 31. To limit the space, the upright walls 30 may be extruded to converge toward one another in an upward direction, as shown in FIG. 2.

Still referring to FIG. 2, biasing members 40 (i.e., one or more) are located inside the U-shaped body of the biased door sweep 10. The biasing members 40 may be leaf springs as in FIG. 2, although other biasing members may be used, such as elastomeric cushions, coil springs, etc. In the case of the leaf springs of FIG. 2, they are sized to be held captive in the elongated tracks 22. Other mechanisms may be used to fix the biasing members 40 to the elongated body 21, such as glue, fasteners, cooperating engagement means, although the biasing members 40 may even be left loosely in the U-shaped cavity of the biased door sweep 10. The biasing members 40 are selected to push the biased door sweep 10 downwardly, when the biased door sweep 10 is mounted to the bottom portion of the door A. Stated differently, the biasing vector is vertically aligned. Accordingly, the biased door sweep 10 seals the gap between the bottom edge surface B of the door A and the ground, by the biasing action of the biasing members 40. If there is a variation in the level of the ground (uneven surface, ledge), the biased door sweep 10 will be capable of moving upwardly in D, to adjust to the gap variation. The biasing member(s) 40 push the biased door sweep 10 down to the floor and allows the sweep 10 to rise up and down for uneven or non-level floor surfaces.

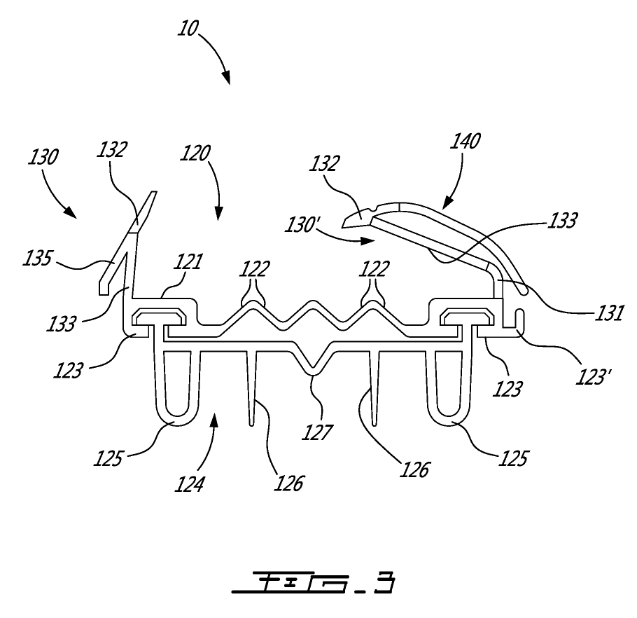

Referring to FIG. 3, the door sweep 10 in accordance with another embodiment, the door sweep with fastener cover, is shown in greater detail. The fastener-cover door sweep 10 has a U-shaped body, with a base 120 and upright walls 130 and 130′, to form an elongated receptacle for installing the fastener-cover door sweep 10 to a lower portion of the door A. The base 120 faces the bottom edge surface B, while the upright walls 130 and 130′ face opposite ones of the main surfaces C. The base 120 may support additional sealing components to seal the gap between the door A and the ground. The upright walls 130 and 130′ are used to secure or hold the fastener-cover door sweep 10 to the lower portion of the door A, as described hereinafter.

The base 120 has an elongated body 121. The elongated body 121 may define one or more elongated channels 122, for the drainage of liquids. Although not visible, throughbore(s) may be in fluid communication with the elongated channel(s) 122, again for the drainage of liquids. Hooks 123 may have their openings face one another (or may face away from one another), on opposite sides of the elongated body 121, to receive edges of a bubble member 124, extending along the elongated body 121. The bubble member 124 may have other names, as described above for the bubble member 25 in the embodiment of FIG. 2. The bubble member 124, also known as insert, may be changed according to the type of door (interior door, exterior door, small gap, large gap). The bubble member 124 is essentially a sealing member 124 that includes brushes, sealing strips, wipers, etc. This applies to 224 as well. Another hook, shown as 123′, projects from a side of the elongated body 121. It is also considered to co-extrude the bubble member 124 with the elongated body 121. The co-extrusion would enable the use of two different materials, or the same material with different properties. As an alternative, some of the parts are extruded separately and the co-extruded or co-molded to into any of the door sweeps 10. The elongated body 121 provides structural integrity to the fastener-cover door sweep 10, while the bubble member seals the gap and provides some insulation. The elongated body 121 may therefore have plastomeric properties, while the bubble member 124 has elastomeric properties to deform while rubbing against the ground. According to an embodiment, the bubble member 214 is an insert that is separate from the body 121. The bubble member 124 may be slid or deformed into engagement with the hooks 123. This arrangement may also be present in the embodiment of FIG. 2. In another embodiment, the bubble member 124 is integral with the elongated body 121.

The bubble member 124 may have various elongated features to perform sealing. One or more elongated bubbles 125 are hollow members that encapsulate air and hence act as insulators. Alternatively, the bubbles 125 may be made of a low-density or medium-density foam to provide insulation. Deflectors 126 (a.k.a., wipers) may also project downwardly to contact the ground. The deflectors 126 form a vapor or liquid barrier, between the body 121 and the floor. An elongated channel 127 may be aligned with the throughbores in the elongated channel(s) 122 to concurrently contribute to the drainage of liquids.

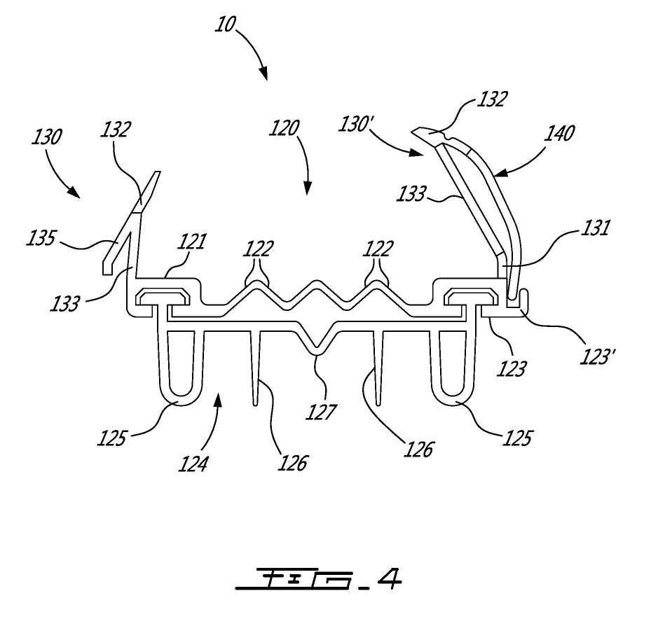

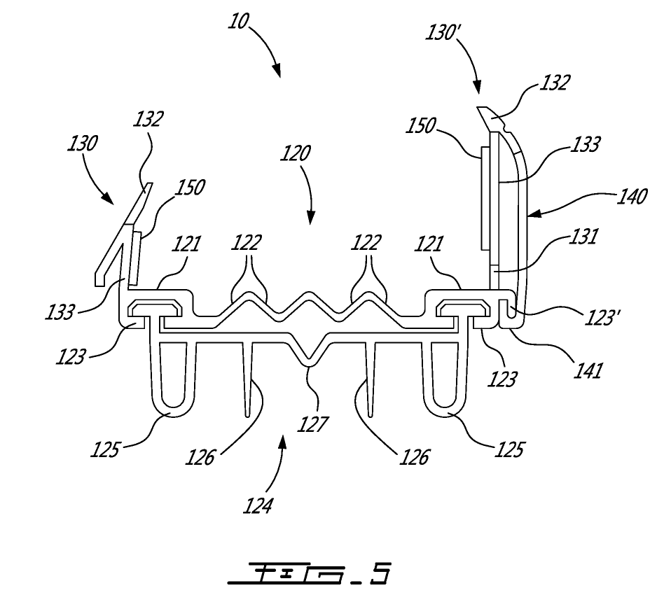

Referring to FIGS. 4 and 5, the upright walls 130 and 130′ project upwardly from the base 120. According to an embodiment, the upright walls 130 and 130′ are elongated and extend concurrently with the base 120. The upright walls 130 and 130′ may be extruded with the base 20, to as to form an integral component. The extrusion of the upright walls 130 and 130′ with the base 120 may be a co-extrusion. As such, the upright wall 130′ may include elongated strips 131 and 132 having greater elastomeric properties, and elongated strip 33 having greater plastomeric properties. The elongated strip 131 may be at a junction between the upright wall 130′ and the elongated body 121 of the base 120. Because of the elastomeric properties, the strip 131 may form a hinge or flexible joint by which the upright wall 130′ may move by elastic deformation. The elongated strips 132, in both upright walls 130 and 130′, may contact the main surfaces C of the door, and therefore form a seal therewith to reduce water penetration. As an alternative embodiment, the elongated strips 131 and 132 may be made of the same material as the elongated strips 133, but thinner, such that the elastomeric properties are derived from the thinness. Other components may be present on the upright walls 130, such as a deflector 135 in the event that the fastener-cover door sweep 10 is used on an exterior door.

The elongated strip 132 on the upright wall 130′ may form a hinge (i.e., flexible joint) for fastener cover 140. Accordingly, the fastener cover 140 may be hinged between the open condition of FIG. 3 and the closed condition of FIG. 4. In the closed condition, a bottom edge of the fastener cover 140 is received in the hook 123′. The elongated strips 133 provide the structural integrity to the upright walls 130. The fastener cover 140 is put in its open condition to expose the upright wall 130′ such that fasteners (e.g., screws) may be installed to secure the fastener-cover door sweep 10 to the main surface C of the door A. The elongated strip 131 may assist in the opening and closing of the fastener cover 140, but may not be necessary.

For installation, the fastener-cover door sweep 10 is positioned on the bottom portion of the door A as shown in FIG. 1. The fastener cover 140 is then hinged opened in the manner shown in FIG. 3. Fasteners such as screws may be used to secure the upright wall 130′ to the main surface C of the door A. The screws may be drilled directly through the upright wall 130′, or in fasteners bores distributed along the wall 130′. Once a suitable number of fasteners secure the fastener-cover door sweep 10 to the door A, the fastener cover 140 may be hinged closed in the manner shown in FIG. 4, thereby concealing the fastener heads.

FIG. 5 shows another possible embodiment, in which the hook 123′ faces downwardly. The fastener cover 140 has a hook end 141 to attach to the hook 123′. It is also considered to locate the hook 123′ on the upright wall 130′. A strip of adhesive 150, such as double-sided tape, may be present to help retain the fastener-cover door sweep 10 until the fasteners are installed.

In the embodiments described above, comolding or co-extrusion techniques are discussed. According to an embodiment, co-extrusion is used, with a TPU (thermoplastic polyurethane) used for its elastomeric properties. In particular, the elongated strips 131 and 132 and the bubble member 124 are made of TPU, while the plastomeric portions of the fastener-cover door sweep 10 are made of vinyls. These are only possible options among many others, such as a thermoplastic rubber (TPR) with a plastomeric material such as a polypropylene (PP). For example, felt may be used as well for its deformable properties.

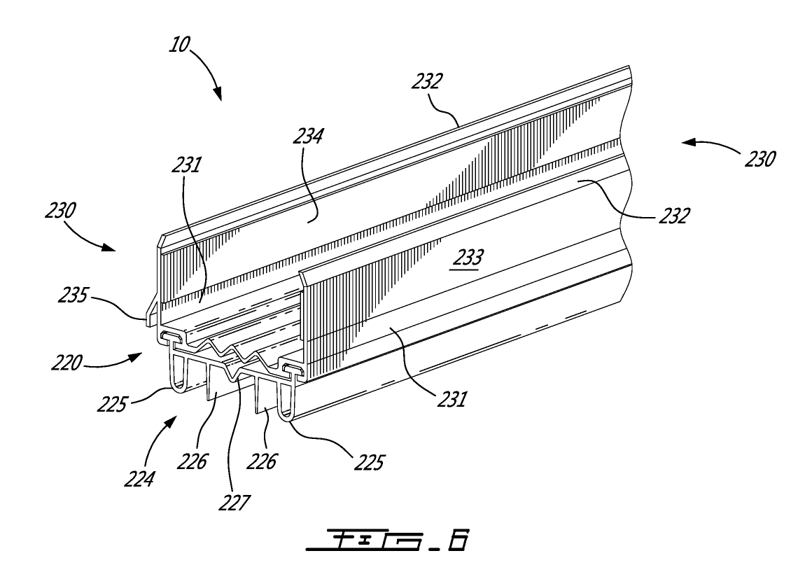

Referring to FIG. 6, the door sweep 10 in accordance with yet another embodiment, the foldable door sweep, is shown in greater detail. The foldable door sweep 10 has a U-shaped body, with a base 220 and upright walls 230, to form an elongated receptacle for installing the foldable door sweep 10 to a lower portion of the door A. The base 220 faces the bottom edge surface B, while the upright walls 230 face opposite ones of the main surfaces C. The base 220 may support additional sealing components to seal the gap between the door A and the ground. The upright walls 230 are used to secure or hold the foldable door sweep 10 to the lower portion of the door A, as described hereinafter.

The base 220 has an elongated body 221. The elongated body 221 may define one or more elongated channels 222, for the drainage of liquids. Although not visible, throughbore(s) may be in fluid communication with the elongated channel(s) 222, again for the drainage of liquids. Hooks 223 may have their openings face one another (or may face away from one another), on opposite sides of the elongated body 221, to receive edges of a bubble member 224, extending along the elongated body 221. However, it is also considered to co-extrude the bubble member 224 with the elongated body 221. The co-extrusion would enable the use of two different materials, or the same material with different properties. The elongated body 221 provides structural integrity to the foldable door sweep 10, while the bubble member 224 seals the gap and provides some insulation. The elongated body 221 may therefore have plastomeric properties, while the bubble member 224 has elastomeric properties to deform while rubbing against the ground. According to an embodiment, the bubble member 224 is an insert that is separate from the body 221. The bubble member 224 may be slid or deformed into engagement with the hooks 223. In another embodiment, the bubble member 224 is integral with the elongated body 221.

The bubble member 224 may have various elongated features to perform sealing. One or more elongated bubbles 225 are hollow members that encapsulate air and hence act as insulators. Alternatively, the bubbles 225 may be made of a low-density or medium-density foam to provide insulation. Deflectors 226 (a.k.a., wipers) may also project downwardly to contact the ground. The deflectors 226 form a vapor or liquid barrier, between the body 221 and the floor. An elongated channel 227 may be aligned with the throughbores in the elongated channel(s) 222 to concurrently contribute to the drainage of liquids.

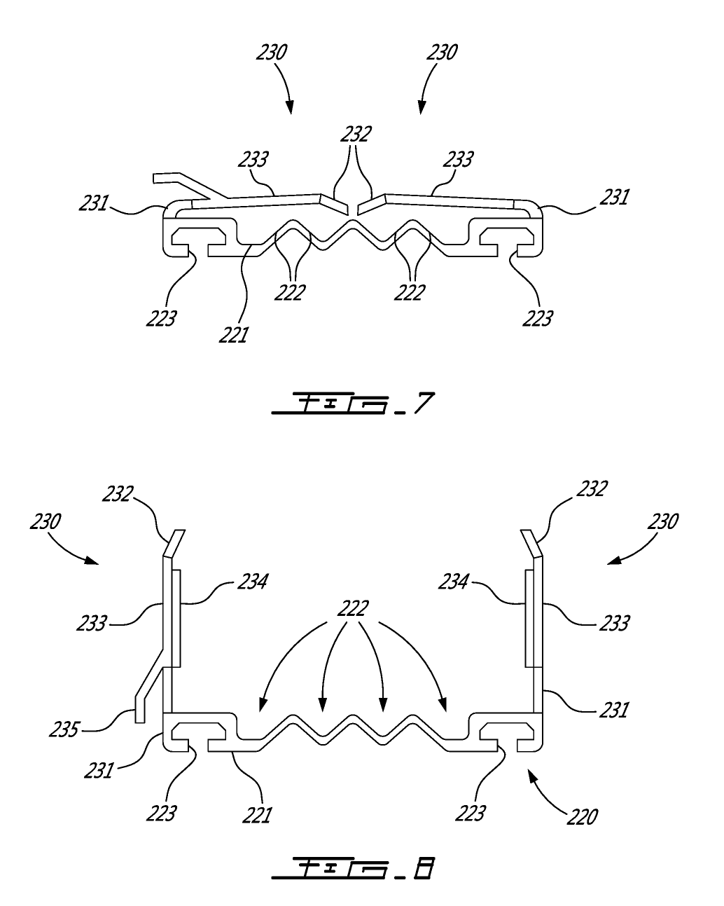

Referring to FIGS. 6, 7 and 8, the upright walls 230 project upwardly from the base 220. However, the upright walls 230 may be hinged into a stowed condition, as shown in FIG. 7. According to an embodiment, the upright walls 230 are elongated and extend concurrently with the base 220. The upright walls 230 may be extruded with the base 220, to as to form an integral component. The extrusion of the upright walls 220 with the base 220 may be a co-extrusion, whereby the upright walls 230 may each include elongated strips 231 and 232 having greater elastomeric properties, and elongated strips 233 having greater plastomeric properties. The elongated strips 231 may be at a junction between the upright walls 230 and the elongated body 221 of the base 220. Because of the elastomeric properties, the strips 231 may form a hinge by which the upright walls 230 may reach their stowed condition of FIG. 7, and then may be arranged to the deployed condition of FIG. 8, for installation. The elongated strips 232 may contact the main surfaces C of the door, and therefore form a seal therewith to reduce water penetration. As an alternative embodiment, the elongated strips 231 may be made of the same material as the elongated strips 233, but thinner, such that the elastomeric properties are derived from the thinness.

The elongated strips 233 provide the structural integrity to the upright walls 230. Adhesive strips 234 may be provided on the elongated strips 233, inside the U-shaped cavity of the foldable door sweep 10, for adhesion of the foldable door sweep 10 to the main surfaces C of the door A. The adhesive strips 234 may be a double-sided tape that may be installed in plant or during domestic installation. The double-sided tape may have a backing layer covering prior to installation. Alternatively or additionally, fasteners such as screws may be used to secure the foldable door sweep 10 to the door A. Other components may be present on the upright walls 230, such as a deflector 235 in the event that the foldable door sweep 10 is used on an exterior door.

Therefore, the foldable door sweep 10 may be sold in the stowed condition of FIG. 7, with or without the adhesive strips 234 installed in the manner shown. According to an embodiment, the foldable door sweep 10 is sold in a unique length, to be cut by the installer on site. The cutting is facilitated by the capability of the foldable door sweep 10 to be folded into the stowed condition of FIG. 7. In such an embodiment, the bubble member 224 (or like sealing component) is sold separated from the foldable door sweep 10 (e.g., kit) with the bubble member 224 cut to the right length and then inserted into a remainder of the shortened foldable door sweep 10. If the adhesive strips 234 are present, backing layers may protect them. For installation, the upright walls 230 are hinged to their deployed condition of FIG. 8. According to an embodiment, the upright walls 230 may be extruded or manufactured for the upright walls 230 to be natural biased toward the stowed condition, such that the foldable door sweep 10 has a tendency to clamp to the door A. The adhesive strips 234 may optionally be installed, and if the bubble member 224 is not integral with the elongated body 221, it may also be clipped, adhered or otherwise connected to the elongated body 221. The foldable door sweep 10 may then be installed to the door in the manner shown in FIG. 1. Fasteners such as screws may be used to secure the upright walls 230 to the main surfaces of the door A.

In the embodiments described above, comolding or co-extrusion techniques are discussed. According to an embodiment, co-extrusion is used, with a TPU (thermoplastic polyurethane) used for its elastomeric properties. In particular, the elongated strips 231 and 232 and the bubble member 224 are made of TPU, while the plastomeric portions of the foldable door sweep 10 are made of vinyls. These are only possible options among many others, such as a thermoplastic rubber (TPR) with a plastomeric material such as polypropylene (PP). For example, felt may be used as well for its deformable properties.

The configuration of the foldable door sweep 10 FIGS. 6-8 could be used in the foldable-cover door sweep 10 of FIGS. 3-5, for the latter to benefit from the advantages of a stowed condition. The door sweeps 10 described herein can conform to a range of door thicknesses.

1. A door sweep comprising:
an elongated U-shaped body formed by a base and a pair of upright walls, the U-shaped body configured for being mounted to a bottom portion of a door, the elongated U-shaped body configured for floating relative to the bottom portion of the door when installed, and
at least one biasing member in the elongated U-shaped body and configured for biasing the downwardly base away from the bottom portion of the door.

2. The door sweep according to claim 1, wherein the at least one biasing member is a leaf spring positioned against the base in the U-shaped body.

3. The door sweep according to claim 2, further comprising low-friction polymer contact strips on the upright walls and configured to slide against the bottom portion of the door.

4. The door sweep according to claim 1, further comprising a plurality of elongated bubbles on a downward surface of the base, the elongated bubbles configured to be against a floor when the door sweep is mounted to the door.

5. The door sweep according to claim 1, wherein the U-shaped body is an integrally extruded member.

6. The door sweep according to claim 1, wherein a pre-installation distance between free ends of the upright walls is configured to be less than a thickness of the bottom portion of the door, such that the upright walls are deformed when mounted to the bottom of the door.

7. The door sweep according to claim 6, wherein the upright walls converge in an upward direction.

8. The door sweep according to claim 6, wherein the pre-installation distance is such that upright walls elastically deform when mounted to the bottom of the door.

9. A door sweep comprising:
an elongated U-shaped body formed by a base and a pair of upright walls, the U-shaped body configured for being mounted to a bottom portion of a door, and
a fastener cover connected to at least one of the upright walls, a hinge formed at a junction between the fastener cover and U-shaped body, for hinging the fastener cover between an opened condition in which the upright wall is exposed to receive fasteners, and a closed position in which the fastener cover is held captive to a remainder of the door sweep.

10. The door sweep according to claim 9, further comprising a hook portion in the base for holding the fastener cover captive in the closed position.

11. The door sweep according to claim 9, further comprising a sealing member releasably connected to the base and configured to be against a floor when the door sweep is mounted to the door.

12. The door sweep according to claim 9, further comprising an elongated strip of elastomeric material at a free end of at least one of the upright walls and configured to be sealingly contacting the door.

13. The door sweep according to claim 9, wherein the hinge is made of an elastomeric material elastically deforming in said hinging.

14. The door sweep according to claim 13, wherein the fastener cover and the upright wall interconnected by the hinge are made of plastomeric materials.

15. The door sweep according to claim 14, wherein at least the fastener cover, the upright wall and the hinge are a co-extruded piece.

16. The door sweep according to claim 9, further comprising hinges formed at a junction between the base and at least one of the upright walls, for hinging the at least one of the upright walls between a stowed condition in which the at least one of the upright walls is stowed toward the base, and a deployed condition in which the at least one of the upright walls are upright for installation to the bottom portion of the door.

17. A door sweep comprising:
an elongated U-shaped body formed by a base and a pair of upright walls, the U-shaped body configured for being mounted to a bottom portion of a door, and
hinges formed at a junction between the base and each of the upright walls, for hinging the upright walls between a stowed condition in which the upright walls are stowed toward the base, and a deployed condition in which the upright walls are upright for installation to the bottom portion of the door.

18. The door sweep according to claim 17, wherein the hinges are made of an elastomeric material elastically deforming in said hinging.

19. The door sweep according to claim 18, wherein the upright walls and the base are made of a plastomeric material.

20. The door sweep according to claim 19, wherein the upright walls, the base and the hinges are a co-extruded piece.
